(19) United States
(12) Patent Application Publication
(10) Pub. No.: US 2022/0120341 A1
(43) Pub. Date: Apr. 21, 2022

(54) VECTORIAL KINETIC DRIVER

(71) Applicant: Alvaro Fabian BRICIO ARZUBIDE, Guadalajara (MX)

(72) Inventor: Alvaro Fabian BRICIO ARZUBIDE, Guadalajara (MX)

(21) Appl. No.: 17/424,394

(22) PCT Filed: Oct. 11, 2019
(86) PCT No.: PCT/MX2019/000103

§ 371 Date: Jul. 20, 2021

(30) Foreign Application Priority Data
Jan. 28, 2019 (MX) MX/A/2019/001160

(51) Int. Cl. F16H 29/12; F16H 63/08

(52) U.S. Cl. CPC F16H 29/12; F16H 63/08

(57) ABSTRACT

A Vectorial kinetic driver mechanism is presented capable of converting the kinetic energy, generated in some spherical elements, into vector impulses, this in order to drive a mass, structure or vehicle in any direction.

### FIELD OF THE INVENTION

This invention relates to man-made machines that give impulse or acceleration to a mass or body and that are used mainly for transportation.

### BACKGROUND OF THE INVENTION

In the search to find new and better ways in the field of transportation, man has developed an extensive variety of machines that, by transforming energy, generate mechanical movement and this is later translated into work.

Much of the mechanical development in this field has been generated using internal or external combustion machines that use the chemical energy of some materials or compounds, in them the direct conversion of this chemical energy is carried out in the movement of a bar or axis and with this will produce an impulse, such is the case of reciprocating engines in automobiles or in aircraft turbines.

Other developments have been made in the development of machines that generate momentum by the accelerated combustion of chemical compounds such as rockets or spaceships.

The present development does not directly apply the energy generated in the combustion of any mineral or fossil fuel to achieve a mechanical impulse, either by the reaction force resulting from the combustion or by the impulse generated in an bar or shaft, in the development here shown, the momentum is obtained by exchanging or absorbing the (kinetic) energy that some elements have to direct it in a given direction or vector.

The kinetic energy that a moving body acquires is given by the laws of Isaac Newton:

F=m*a

Fc=r*w\hat{ }2*m

F: (Force)

Fc: (Kinetic Force)

Obtaining and subsequently transforming this energy into a mechanical impulse in one direction is the fundamental theme of the present development.

Other developments such as those shown in U.S. Pat. No. 3,555,915 issued to H. W. Young, U.S. Pat. No. 3,756,086 granted to McAlister, or U.S. Pat. No. 3,810,394 granted to Novak have tried to achieve this with mechanisms that use the centrifugal and gyroscopic force of the elements that make them up, however, to date it has not been possible to obtain a machine with relative mechanical efficiency because the transformation and operation principles on which they have been based are wrong, since they have tried to obtain momentum using redundant mechanisms, that is, they have tried to obtain it from elements already owned by their mechanical configurations.

To achieve this, it is necessary to technologically develop a mechanical, chemical, electrical or magnetic model (or a combination of these) that allows obtaining an impulse (kinetic energy) starting from elements outside these systems.

### GENERAL DESCRIPTION OF THE INVENTION

A mechanism is presented that achieves a mechanical impulse by the transformation of rotary kinetic energy of some metallic spherical bodies, which have previously accumulated it, and which transmit or exchange it through this mechanism, to translate it into a vector mechanical impulse, that is, in one direction.

To achieve this, a rotary kinetic generator has been developed which consists of a circular disk with ducts or pipes on one or both sides, in these ducts, together with the circular disk, metallic bodies, preferably spherical, are rotated at high speeds, this it is done in order to obtain a high kinetic energy in them. In a second step it is desired to transfer this energy to convert it into a mechanical impulse, for this, once a high rotational speed has been achieved, the metallic spheres are released one by one and they are channeled through a vector conduit that has one or more concentrically placed elements called kinetic energy exchangers, these vector conduits are pipes of circular section that have a first straight segment and a second segment of irregular shape, in them the spherical bodies will be circulated and at the end they will be channeled to the spherical bodies feeder located in the center of the disk, so that they are used again, the vector conduit is mounted on a rail that allows it to move in order to receive the spherical body that is ejected from the kinetic energy generating disk; Along the straight segment of the vector conduit, as in the irregular segment of this conduit, energy exchangers are located, in their movement through this conduit the spherical bodies will impact the exchangers directly (physically) or through a medium as it can be a magnetic field, gradually transferring a little kinetic energy in each one of them, kinetic energy exchangers are elements whose operating principle can be mechanical, electrical or magnetic and, by means of these, by opposing its displacement, the kinetic energy of the spherical bodies is transferred to the structure where the energy exchangers have been fixed, in summary, through this configuration, the kinetic energy exchangers are attacked with spherical bodies of high energy content, which will print or transmit this energy just in the direction or vector to which it is directed the vector duct. The metallic spheres will give up most of their energy, reserving only enough so that, on their return, they can reach the sphere feeder that feeds said disk (from its center of rotation) to be used again. During the return journey, electric generators are located to take advantage of the remaining energy of the metallic spheres, once the metallic spheres have reached the feeder they will advance through the channels that the disc has due to the effect of the centrifugal force, this movement is performed from the center or axis of the disk to the end of it, thereby gradually gaining high kinetic energy, that is, the spherical bodies will increase their kinetic energy at each of the levels that are located on their path from the center to the periphery of the energy-generating disk.

The use of a trigger, which can be of the mechanical or electromagnetic type, placed perpendicular to the channels of the kinetic energy generating disk, exactly at the positions of the spherical element, serves as an ejector so that these spherical bodies are fired (tangentially) in the direction of the vector conduit, both the trigger and the vector conduit move radially in order to eject the spherical body that has the required kinetic energy, this trigger not only directs the metallic spherical element into the vector conduit, but also prints it an additional speed or kinetic energy. To achieve precision in the direction or moment of firing, this trigger is actuated through high-speed sensors, such as sensors actuated by laser or infrared light. It can have an equivalent number of spherical bodies and triggers on the radial channeling in the kinetic energy generating disk or can also be placed a mobile trigger that selects the spherical body to be fired based on the impact force that is required to be transmitted to the kinetic energy exchangers.

The energy exchangers referenced above can be of the mechanical, electrical or magnetic type, in the first case, the exchanger consists of a series of solid elements that absorb the energy of the spherical element, a sample of this can be a nozzle with a series of conical triangular vanes placed around the vector duct, thus, as the metallic sphere passes, they will try to mechanically hold it, leaving it to escape only to continue its journey to repeat this process in the next element positioned ahead of it, the resistance level of these conical vanes can be regulated by a computer controlled variable resistance element, this in order to offer a resistance that allows the sphere to transmit the greatest amount of energy during its travel through the vector conduit and to retain enough remaining kinetic energy to be able to return to the feeder generation disk of kinetic energy to be used later when required. Another example of mechanical kinetic energy exchangers is the use of open circular meshes of steel cable or of some material with a high level of creep or yield, whose internal diameter is less than the diameter of the spherical body, in this case, multiple meshes are placed coaxially along the vector conduit and the spheres are made to pass at high speed through them, on its way, the sphere will transmit or exchange a little of its force in each of them, comparatively and unlike energy exchangers magnetic kinetics that I present below, in both previous examples, the exchanged force gradient will be higher. In a second case, these exchangers can have an electrical operating principle, where the spherical body is polarized with an electrical charge, this will be made to circulate through a series of windings placed coaxially to the vector conduit and that produce electrical current, the inductive resistance The resulting body will force the spherical body to transmit its kinetic energy to the structure where the windings are attached. In a third type (magnetic) of kinetic energy exchanger, a set of magnetic coils placed coaxially to the vector conduit are used, a system that is assisted by a bank of capacitors to increase the intensity of the magnetic field (symbolized by B) at the moment of shot, a computing system supported by a series of sensors (which can be of the magnetic or infrared type) at the output and input of each magnetic coil determine the speed of the metallic spherical body at the entrance of the vector conduit and thereby determine the intensity of the current and magnetic field required to absorb, Through the resistance to movement created by the formation of the magnetic field, the kinetic energy of the spherical body, in this case spherical bodies made of materials with high magnetic permeability are used, such as ferrous alloys with a high content of Nickel (Ni) and Molybdenum (Mo).

The development shown above is capable of driving any structure, moreover, the gyroscopic effect produced by the movement of the disk that generates kinetic energy at high speed also confers operational stability when they are used for the mobility of a vehicle. Vectorial kinetic drives must have multiple vector conduits that allow the impulse in different directions (which can be done practically at the same moment due to the great angular velocity of the disk), likewise the vectorial kinetic drivers can be mounted on a structure to be supported on one or more axes that allows it to rotate and thus direct the impulse polarly (spherically) in any desired direction or vector, this can also be achieved through combined shots through two or more vector conduits to different directions, where the resulting impulse vector will be the product of the sum of said vectors.

The firing capacity of said spherical elements, a product of the huge angular velocity at which the disc rotates, allows a large number of shots to be made in short periods of time, which allows a great vector force applied to the kinetic energy exchangers to be averaged over the period of time in operation, thus, the resulting impulse will be the vector sum of multiple small impulses whose sum will be particularly large, also this will be appreciated with uniformity, achieving uniform rectilinear movements of acceleration or deceleration, likewise, increasing or decreasing the angular velocity of the disk generator of kinetic energy and therefore the kinetic energy of the spherical bodies that are in the ducts or pipes located on the face or faces of this, the impact force of the spherical bodies in the kinetic energy exchangers can be increased or decreased.

The elements that make up this mechanism are:

1.—Structure 2.—Kinetic energy generator disk 3.—Ducts 4.—Trigger. 5.—Engine 6.—Transmission. 7.—Speed sensors. 8.—Vectorial Duct. 9.—Magnetic Coil. 10.—Cable mesh. 11.—Conical vane nozzle 12.—Straight section of the vector conduit. 13.—Irregular section of the duct (return). 14.—Mechanical type kinetic energy exchanger. 15.—Magnetic type kinetic energy exchanger. 16.—Spherical metallic bodies 17.—Fixing screws 18.—Position sensor of spherical bodies 19.—Computer 20.—Axis. 21.—Sphere feeder. 22.—Controller. 23.—Vector impulse. 24.—Magnetic Field. 25.—Vector duct rail 26.—Trigger rail. 27.—Articulated vector duct joint. 28.—Exit guide. 29.—Trigger position sensor.

Having described the nature of the present invention, a particular example is described with references to the accompanying drawings. However, those skilled in the art will appreciate that many variations and modifications can be devised without departing from the scope of the invention as described above.

### DESCRIPTION OF THE FIGURES

FIG. 1.—Side view of one vector conduit vectorial kinetic driver with magnetic type kinetic energy exchanger.

FIG. 2.—Side view of one vector duct kinetic energy exchanger with a conical nozzle kinetic energy exchanger.

FIG. 3.—Side view of the cable mesh mechanical kinetic energy exchanger.

FIG. 4.—Side view of the vectorial kinetic driver with 4 vector conduits with a magnetic type kinetic energy exchanger.

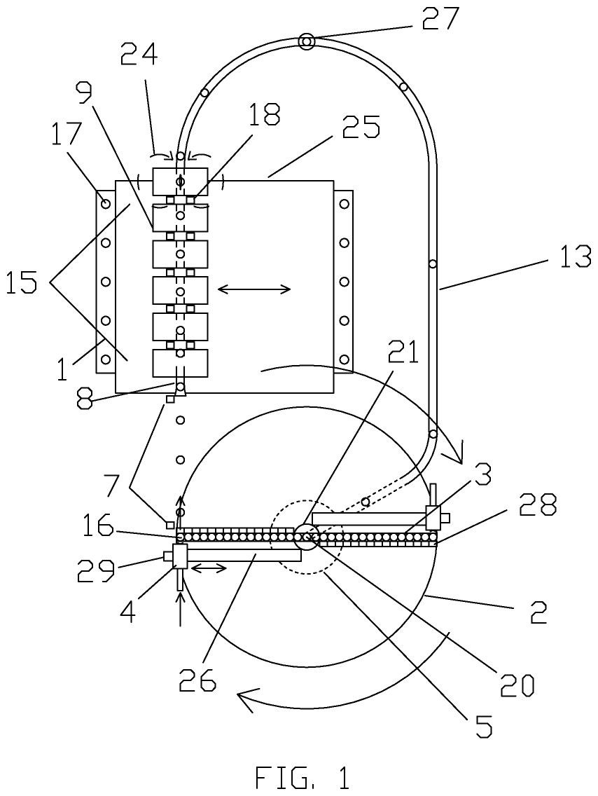

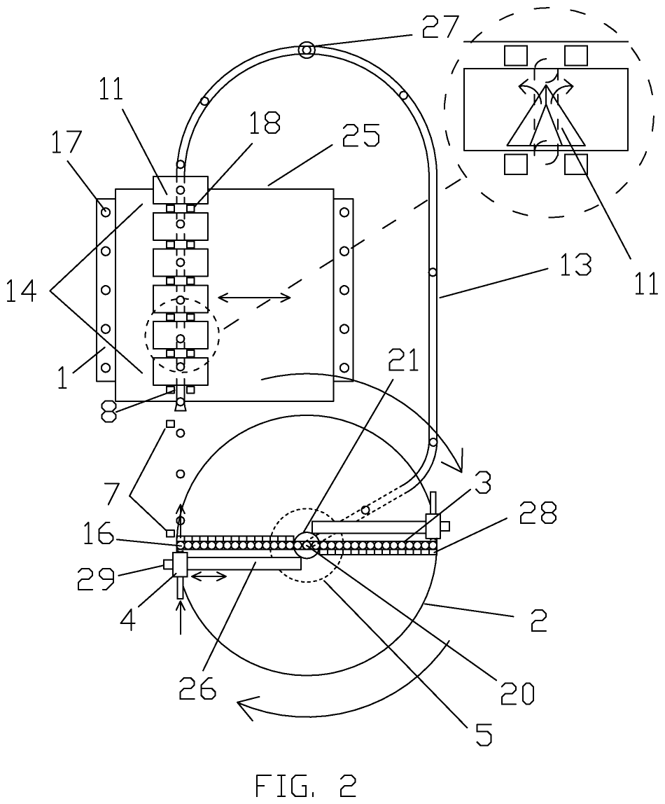

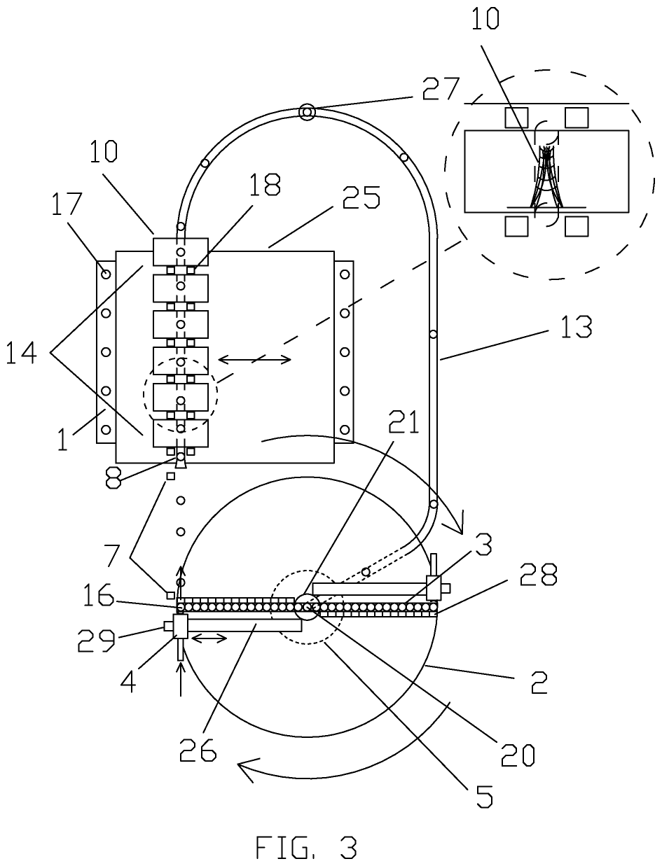

### EXAMPLE OF THE OPERATION OF A VECTORIAL KINETIC DRIVE OF AT LEAST ONE VECTOR DUCT. (FIGS. 1 TO 4)

The motor (5) rotatably drives, either directly or through a transmission (6), a disk (2) that generates kinetic energy at high angular speed, where a series of ducts (3, located on their faces, house metallic spherical bodies (16), these are located in an orderly manner from the center or axis of the disk (20) to its perimeter, in a rectilinear arrangement positioned radially, which could also be curved, thus, when the generator disk (2) rotates, spherical metallic bodies (16) acquire kinetic energy, here being those on the periphery of the disk those with the highest kinetic energy, once the disk (2) has reached the desired angular speed, it will be a controller (22) which, through the trigger (4) (the latter may be mechanical or electromagnetic type) and that is activated through a high-speed position sensor of the trigger (29) (such as laser light sensors) that will trigger one of the metallic spheres bodies (16) located in the channeling (3) of the disk, selecting it in relation to the potential energy that this spherical body is desired to have, these will have greater kinetic energy as they move away from the center or axis (20) of the disk, this will be thrown tangentially to the radius and coplanar to the plane in which the disk (2) rotates, directing it exactly to the point where the vector conduit (8) is located and therefore to the set of kinetic energy exchangers (14) and (15), to the entrance of this vector conduit are located two speed sensors (7) that can be, to mention an example, of the magnetic or infrared type, and that, with the help of a computer (19), calculate the speed of the metallic sphere to determine the deceleration speed, that is, the speed with which the transfer of the kinetic energy that the metallic sphere possesses to the kinetic energy exchangers is desired, this will be achieved by increasing or decreasing the resistance that these will oppose to the passage of the metallic sphere through them, for example, in kinetic energy exchangers of the mechanical type (14), a series of conical vane nozzles will allow the spheres to pass through only once they have impacted on them and, due to the kinetic force, have forced them to overcome the spring that holds them together and allows them to expand in order to be able to cross them, a second example of metal exchangers that is presented are those whose operating principle is magnetism (15) where a set of magnetic coils driven by a charging source and capacitor circuit, generates an intense magnetic field (24), with the help of positioning (18) and speed (7) sensors the force will be determined or energy remaining in them, these will circulate through them until between the exchangers and the spheres practically the difference in kinetic energy between them is a value close to zero, it is at that moment that the spheres are released from all resistance in order to maintain enough momentum for them to continue through the conduit and return to the disk feeder (21) and restart the cycle described above again (and again).

The time between firings of metallic spherical bodies (16) can be as short or long as required, the high rotation speed of the energy generating disk (2) and the power system (21), channeling (3) and acquisition of kinetic energy in the spheres, allow the controller (22) to make multiple shots in the direction in which the vector conduit (8) is oriented and that will produce vector impulses (23) in said direction that, due to their multiplicity, they will show up as a long pulse of uniform magnitude.

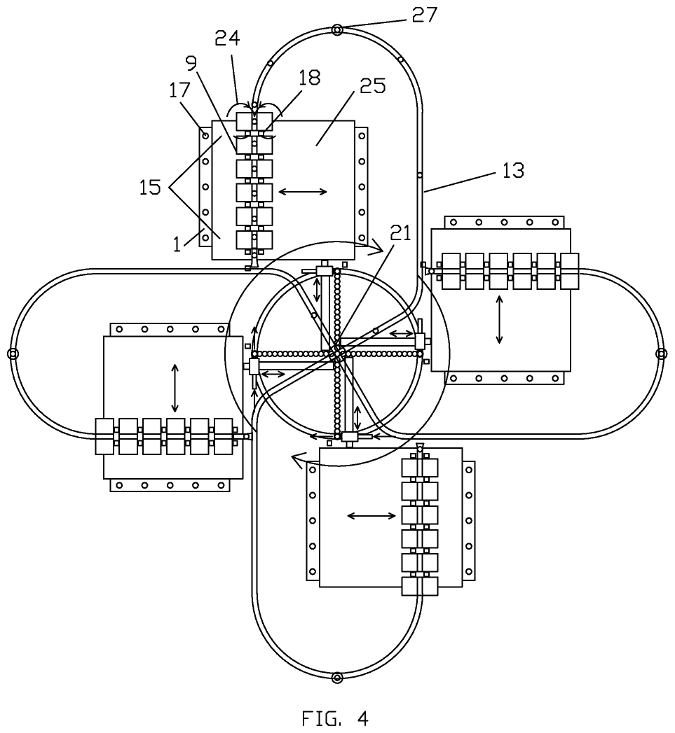

Vectorial kinetic drivers of more than one vector conduit (8) like the one shown in FIG. 4, achieve a great impulse in different directions, this is very useful when being installed in vehicles, since they can move without the need of air as a medium for their impulse, direction or support, as currently required by all aircrafts, finally, the installation of this development in space vehicles will allow safe, permanent and powerful propulsion without the requirement of the use of highly flammable fuels with which rocket engines are currently fed, whose weight and cost are very high, and ironically, once the fuel runs out are thrown away.

Having sufficiently described my invention, I consider as a novelty and therefore I claim as my exclusive property what is contained in the following clauses:

1. Vectorial kinetic driver comprising:
A Structure (1);
A kinetic energy generating disk (2);
At least one vector conduit (8);
At least one trigger (4);
At least one kinetic energy sensor (7);
At least one position sensor (18);
An operation computer (19);
An operation controller (22);
Characterized by the fact that the kinetic energy generating disk (2), which rotates on its axis (20) at high speed, is driven by a motor (5), which, on at least one of its faces, the generating disk kinetic energy has radial channels (3) where are located and circulate, from its center to the periphery, spherical bodies (16); That the vector duct (8) is an element of circular section, that its first part is straight and is placed orthogonally and coplanar to the radial ducts (3) of the energy-generating disk (2), that said vector duct (8) is mounted on a linear displacement rail (25) that, like the energy-generating disk (2), is fixed to the structure (1), whose final part is irregular and ends its journey in the disk feeder (21); That both in its straight part and in its irregular part said vector conduit (8) has kinetic energy exchange elements (15), speed (7) and position sensors (18); It has a trigger (4) with spherical bodies (16) that is mounted on a rail (26) for its radial linear displacement and this rail fixed to the kinetic energy generating disk (2), perpendicular to the radial ducts (3); Which is driven by at least one controller (22) that determines the direction of the impulse and a computer (19) that determines and controls the selection of the spherical bodies, as well as the frequency and direction of the shots to achieve the impulse in the direction vector desired.

2. Vectorial kinetic driver as mentioned in claim 1 wherein the kinetic energy generating disk (2) is driven indistinctly by a mechanical transmission, magnetic transmission, electric motor, internal combustion engine, external combustion engine or the combination of some of these.

3. Vectorial kinetic driver as mentioned in claim 1 wherein the principle of operation of the kinetic energy exchangers is, indistinctly, mechanical, electrical, magnetic, or a combination of some of them.

4. Vectorial kinetic driver as mentioned in claim 1 wherein the operating principle of the positioning (18) and speed (7) sensors are indistinctly, mechanical, electrical, magnetic, optical, infrared, laser or the combination of some of them.

5. Vectorial kinetic driver as mentioned in claim 1 wherein the operating principle of the trigger (4) of spherical bodies (16) is of the mechanical, electromagnetic type or a combination of both.
